(19) United States
(12) Patent Application Publication
(10) Pub. No.: US 2010/0193499 A1
(43) Pub. Date: Aug. 5, 2010

(54) MULTIPLE ACCESS MICROWAVE OVEN

(76) Inventor: John Z. Blazevich, San Pedro, CA (US)

Correspondence Address: CHRISTIE, PARKER & HALE, LLP, PO BOX 7068, PASADENA, CA, 91109-7068, US

(21) Appl. No.: 12/365,137

(22) Filed: Feb. 3, 2009

(51) Int. Cl. A21B 1/00

(52) U.S. Cl. 219/394

(57) ABSTRACT

A microwave oven with multiple cooking chambers. The microwave oven includes a cabinet and at least two cooking chambers within the cabinet. Each of the at least two cooking chambers has an opening at a front side of the cabinet, and the at least two cooking chambers are independently operable. At least two doors are provided on the front side of the cabinet for opening and closing the respective openings of the at least two cooking chambers.

### FIELD OF THE INVENTION

The present invention is related to a microwave oven, and more particularly, to a microwave oven with more than one cooking chamber and multiple access doors.

### BACKGROUND OF THE INVENTION

A microwave oven is a cooking appliance that cooks and/or heats food with microwave radiation. The microwave oven cooks and/or heats food by using microwave radiation to heat water or other polarized molecules contained in the food.

A conventional microwave oven contains a single cooking chamber for cooking and/or heating food. Therefore if there are multiple food items to be cooked and/or heated, the food items are generally cooked and/or heated sequentially (i.e., one after another). Alternatively, if all food items can fit into the single cooking chamber, they may be cooked and/or heated altogether; however, unless the multiple food items are of the same or similar kinds, they generally have different cooking requirements such as power level and cooking/heating time. Therefore, it is generally not desirable to prepare multiple food items in the single cooking chamber in the same cooking/heating session. Accordingly, it is desirable to provide a microwave oven that can cook/heat multiple food items with improved efficiency and result.

### SUMMARY OF THE INVENTION

Embodiments of the present invention provide a microwave oven having multiple (i.e., at least two or more) independently operable cooking chambers. Each of the multiple cooking chambers has a separate access door for opening and closing the corresponding cooking chamber. The microwave oven according to embodiments of the present invention further includes a control panel for separately controlling the operations of the at least two cooking chambers.

According to an embodiment of the present invention, a microwave oven includes a cabinet and at least two cooking chambers within the cabinet. Each of the at least two cooking chambers has an opening at a front side of the cabinet, and the at least two cooking chambers are independently operable. The microwave oven further includes at least two doors on the front side of the cabinet for opening and closing the respective openings of the at least two cooking chambers.

In one aspect of the embodiment, the at least two cooking chambers may be adjacent to each other vertically in a height direction of the cabinet.

In one aspect of the embodiment, the at least two cooking chambers may be adjacent to each other horizontally in a length direction of the cabinet.

In one aspect of the embodiment, the at least two doors may be rotatably hinged to the cabinet.

In one aspect of the embodiment, the at least two doors may be rotatable around an axis that is parallel to a height direction of the cabinet.

In one aspect of the embodiment, the at least two doors may be hinged to respective side edges of the at least two cooking chambers.

In one aspect of the embodiment, the at least two doors may be rotatable around an axis that is parallel to a length direction of the cabinet.

According to another embodiment of the present invention, a microwave oven includes a cabinet and at least two cooking chambers within the cabinet. Each of the at least two cooking chambers has an opening at a front side of the cabinet, and the at least two cooking chambers are independently operable. The microwave oven further includes at least two doors on the front side of the cabinet for opening and closing the respective openings of the at least two cooking chambers, and a control panel for controlling the two cooking chambers.

In one aspect of the embodiment, the control panel may include a keypad for entering operation parameters of the at least two cooking chambers.

In one aspect of the embodiment, the keypad may include first keys allocated to control one of the at least two cooking chambers, and second keys allocated to control another one of the at least two cooking chambers.

In one aspect of the embodiment, the keypad may include a key for selecting one of the at least two cooking chambers to receive subsequent inputs from the keypad.

In one aspect of the embodiment, the control panel may further include at least one display unit for concurrently displaying operation status of the at least two cooking chambers.

In one aspect of the embodiment, the control panel may further include at least two latches for controlling the opening and/or closing of the at least two doors independently.

In one aspect of the embodiment, the microwave oven further includes at least one heating unit for providing microwaves to the at least two cooking chambers.

In one aspect of the embodiment, the at least one heating unit includes at least one magnetron for providing microwaves to the at least two cooking chambers.

In one aspect of the embodiment, the at least one heating unit includes at least two magnetrons for providing microwaves to the least two cooking chambers respectively.

In one aspect of the embodiment, the at least one heating unit includes at least two heating units.

In one aspect of the embodiment, each of the least two heating units includes a magnetron for providing microwaves to a corresponding one of the at least two cooking chambers.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic drawing illustrating a front view of a microwave oven having two cooking chambers according to an embodiment of the present invention.

FIG. 2 is a schematic drawing illustrating a perspective view of the microwave oven of FIG. 1.

FIG. 3a is a cross sectional view of the microwave oven of FIG. 2.

FIG. 3b is a cross sectional view of a microwave oven according to an embodiment of the present invention.

FIGS. 4a-4d are schematic drawings illustrating various door configurations according to embodiments of the present invention.

FIG. 5 is a schematic drawing illustrating a perspective view of a microwave oven according to an embodiment of the present invention.

FIGS. 6a-6d are schematic drawings illustrating various door configurations according to embodiments of the present invention.

FIG. 7 is a schematic drawing illustrating a perspective view of a microwave oven according to an embodiment of the present invention.

### DETAILED DESCRIPTION OF EXEMPLARY EMBODIMENTS

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when an element is referred to as being “on” another element, it can be directly on the another element or be indirectly on the another element with one or more intervening elements interposed therebetween.

Embodiments of the present invention provide an improved microwave oven having multiple cooking chambers to cook or heat multiple food items in separate cooking chambers. The multiple cooking chambers can be operated independently, therefore multiple food items can be prepared in separate but concurrent cooking/heating sessions. Accordingly, the microwave oven according to the embodiments of the present invention can cook or heat multiple food items with improved efficiency and result.

A microwave oven is a cooking appliance that cooks and/or heats food by electronic heating. During electronic heating, microwave radiation (e.g., 2.45 GHz microwave) heats up the water molecules or other polarized molecules (e.g., fat) within the food item being cooked or heated. A typical microwave oven includes a high voltage transformer, which supplies high-voltage electric energy to a magnetron. The magnetron converts the high-voltage electric energy to microwave radiation. The microwave oven also includes a magnetron control circuit (e.g., a microcontroller), a waveguide and a cooking chamber. The waveguide directs the microwave radiation to the cooking chamber where the food is cooked and/or heated. The microwave oven generally allows the user to choose between several power levels and/or different cooking/heating operations such as high power, medium power, low power and defrosting. Since the microwave oven provides an efficient way of cooking and heating food, the microwave oven has been widely adopted in both home kitchens and commercial facilities.

Although the microwave oven is fast and efficient, when multiple food items are cooked and/or heated by using the microwave oven with a single cooking chamber, only one food item can be cooked and/or heated at a time. While all the food items may fit into the single cooking chamber, it is generally not practical to prepare multiple food items in one cooking and/or heating session because the food items may require different power settings and/or cooking times. When multiple users are sharing a single microwave oven, in theory, they may share the microwave oven to cook and/or heat each user's food item in one cooking and/or heating session, but, in most circumstances, the users are not likely to feel comfortable to share the microwave oven to cook and/or heat food items in the same cooking and/or heating session. Therefore, the users most likely will take turns using the microwave oven in separate cooking and/or heating sessions.

One solution to the above described problems is to install multiple microwave ovens in a facility at additional cost; however, there may not always be available space for installing multiple microwave ovens. Therefore, it is desirable to provide a microwave oven having multiple cooking chambers with a size comparable to a typical single cooking chamber microwave oven or at least smaller than two separate microwave ovens, but large enough for most individual requirements.

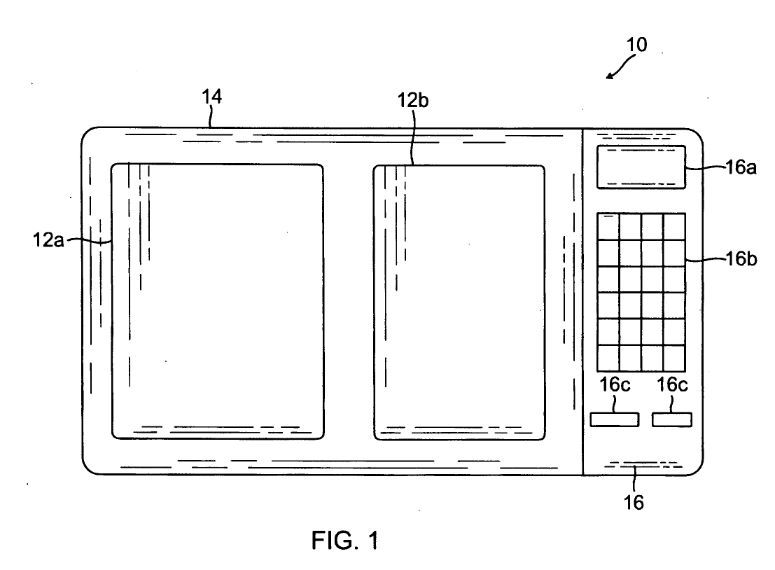

FIG. 1 is a schematic drawing illustrating a front view of a microwave oven having two cooking chambers according to an embodiment of the present invention.

Referring to FIG. 1, a microwave oven 10 includes two cooking chambers 12a and 12b within a cabinet 14. For ease of illustration, the doors of the cooking chambers 12a and 12b are not shown in FIG. 1. The two cooking chambers 12a and 12b are adjacent to each other horizontally in FIG. 1. The microwave oven 10 also includes a control panel 16 for providing a user interface to operate the microwave oven 10. According to an embodiment of the present invention, the control panel 16 includes a display unit 16a, a keypad 16b and two latches (or other suitable mechanisms) 16c for controlling the opening and closing of the doors of the two cooking chambers 12a and 12b.

In an embodiment of the present invention, the control panel 16 includes two separate keypads 16b for controlling the two cooking chambers 12a and 12b respectively. As such, two users can concurrently input commends on the two separate keypads to control the respective cooking chambers. Further, in another embodiment of the present invention, the control panel 16 includes two separate display units for displaying respective information of the two cooking chambers 12a and 12b separately.

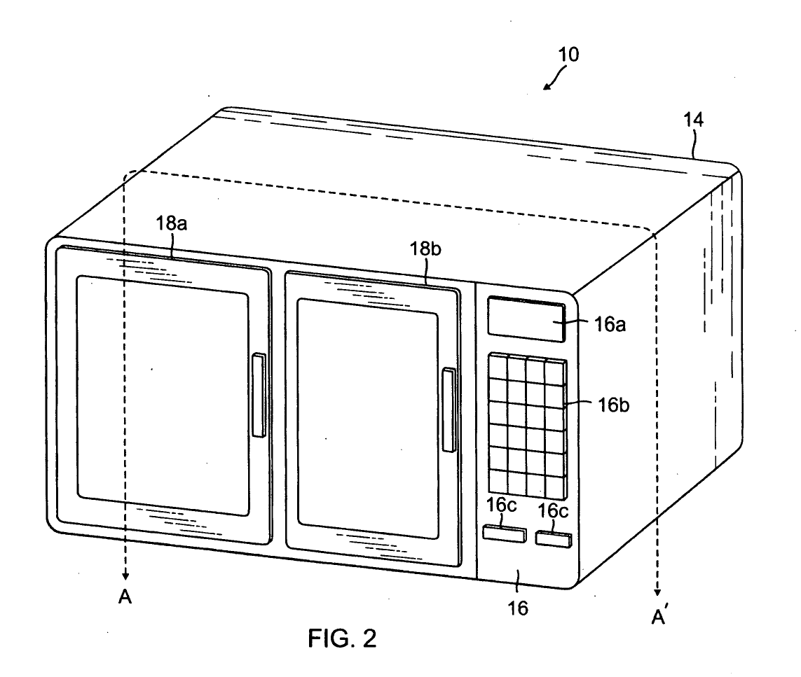

FIG. 2 is a schematic drawing illustrating a perspective view of the microwave oven of FIG. 1.

Referring to FIG. 2, two doors 18a and 18b are rotatably hinged to the cabinet 14. When the two cooking chambers 12a and 12b are closed by the two doors 18a and 18b, respectively, the two cooking chambers are effectively Faraday cage enclosures which prevent the microwave from escaping into the environment. The two doors 18a and 18b each may include a glass panel for easy viewing according to an embodiment of the present invention. The glass panel has a layer of conductive mesh to maintain the shielding effect. The size of the perforations or holes in the mesh should be much less than the wavelength of the microwave to prevent the microwave radiation from passing through the door, while visible light (with a much shorter wavelength) can.

The display unit 16a of the control panel 16 provides status information on the two cooking chambers 12a and 12b. The status information may include, for example, cooking time, power level, mode setting, time and time lapsed. The display unit 16a may display the respective status of the two cooking chambers 12a and 12b concurrently or sequentially. Further, the display unit 16a may display text and/or graphical information. In some embodiments, the display unit may include a liquid crystal display or a fluorescent display. The keypad 16b allows a user to input commends to control the operations of the two cooking chambers. In some embodiments, the keypad 16b may include membrane switches and/or mechanical switches. Different keys of the keypad 16b may be allocated to control the two cooking chambers respectively. As such, two users my operate the two cooking chambers concurrently. Alternatively, the keypad 16b may control the two cooking chambers sequentially using the same keys. In an embodiment according to the present invention, the keypad 16b may include cooking chamber selection keys (e.g., Chamber A key and Chamber B key). When a user presses the Chamber A key, subsequent inputs on the keypad 16b are directed to control the cooking chamber 12a. Instead, when the user presses the Chamber B key, subsequent inputs on the keypad 16b are directed to control the cooking chamber 12b.

According to another embodiment of the present invention, the keypad 16b includes a single cooking chamber selection key. Each time the key is pressed by the user, the currently selected one of the cooking chambers 12a and 12b is unselected, and the unselected one of the cooking chambers 12a and 12b becomes selected.

According to an embodiment of the present invention, the control panel 16 includes two latches (or other suitable mechanisms) 16c for controlling the opening and/or closing of the two doors 18a and 18b. According to an embodiment of the present invention, when the user depresses one of the two latches 16c, a corresponding one of the two doors 18a and 18b is opened.

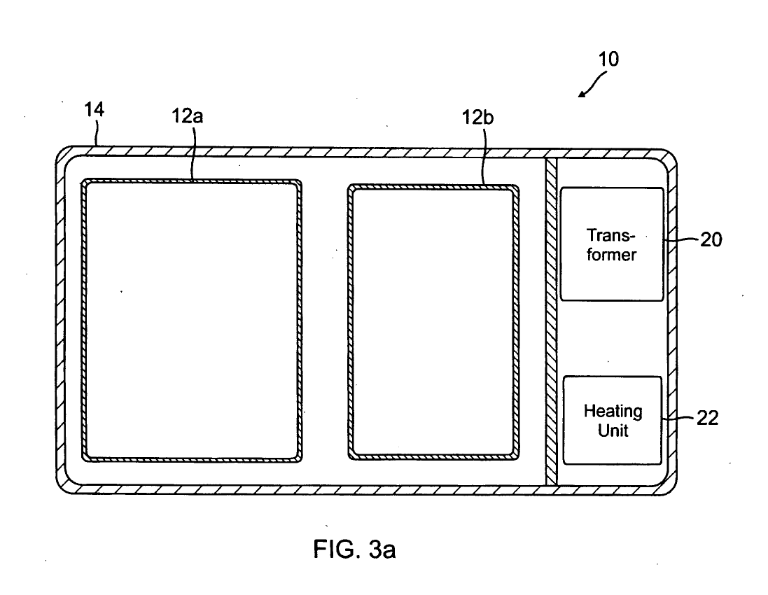

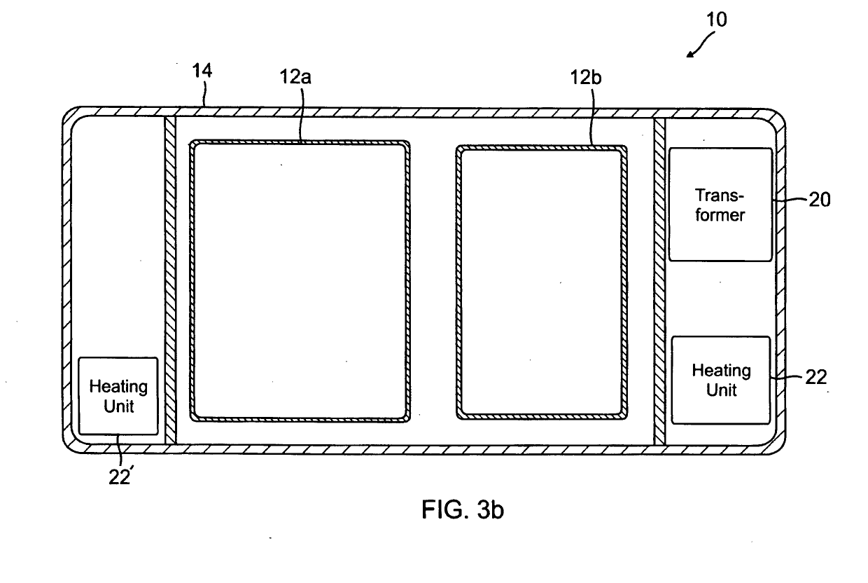

FIG. 3a is a cross sectional view of the microwave oven of FIG. 2 along the line A-A′.

Referring to FIG. 3a, the microwave oven 10 includes at least one high voltage transformer 20 for supplying high-voltage electric energy to at least one heating unit 22, which includes at least one magnetron. The magnetron powered by the high-voltage electric energy generates microwaves that are guided to the two cooking chambers 12a and 12b by at least one suitable waveguide.

In some embodiments of the present invention, the microwave oven 10 may include more than one heating unit 22 each including at least one magnetron for generating microwaves. FIG. 3b is a cross sectional view of an exemplary microwave oven having two heating units according to an embodiment of the present invention. Referring to FIG. 3b, the microwave oven 10 includes two heating units 22 and 22′ located on the left and right sides of the microwave oven 10 respectively. However, the present invention is not limited thereto; instead, the two heating units 22 and 22′ may be arranged differently (e.g., both on the left sides or right sides of the cabinet 14 or other suitable configurations). In one exemplary embodiment, two or more cooking chambers (e.g., cooking chambers 12a and 12b) are supplied with microwaves from two or more separate heating units 22 via separate waveguides respectively. In another embodiment, one heating unit 22 includes two or more separate magnetrons, each of which supplies microwaves to a corresponding one of the two or more cooking chambers by at least one suitable waveguide. In still another embodiment, the heating unit 22 includes one magnetron for supplying microwaves to the two or more cooking chambers by at least one suitable waveguide. One skilled in the art would appreciate that the at least one suitable waveguide divides and directs the microwaves from the magnetron or magnetrons of the at least one heating unit in the above described embodiments to the two or more cooking chambers according to the power requirements of the two or more cooking chambers.

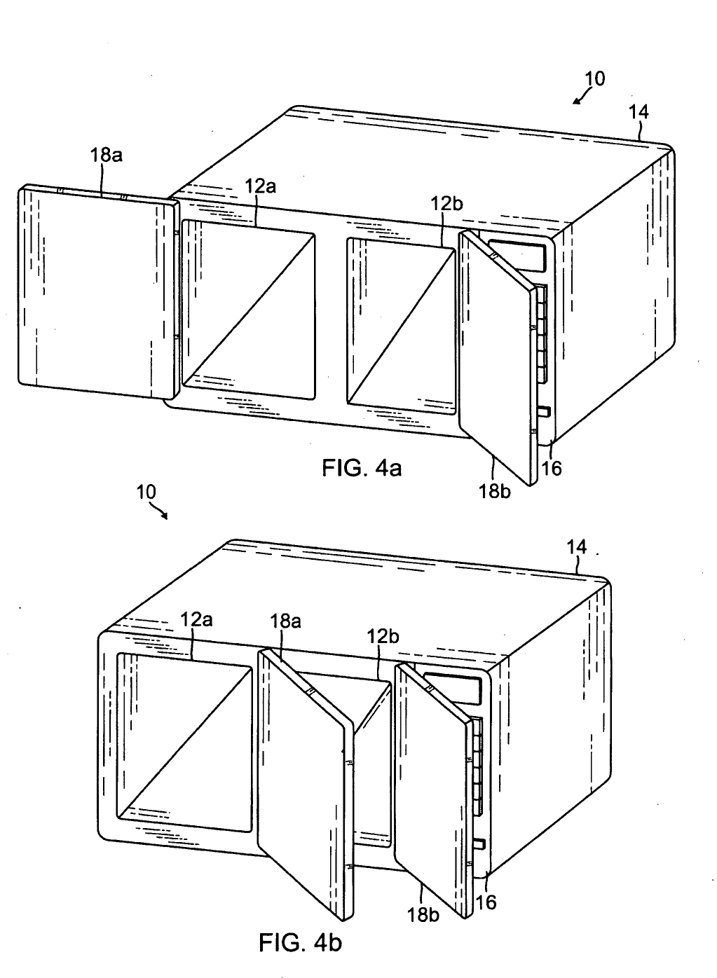

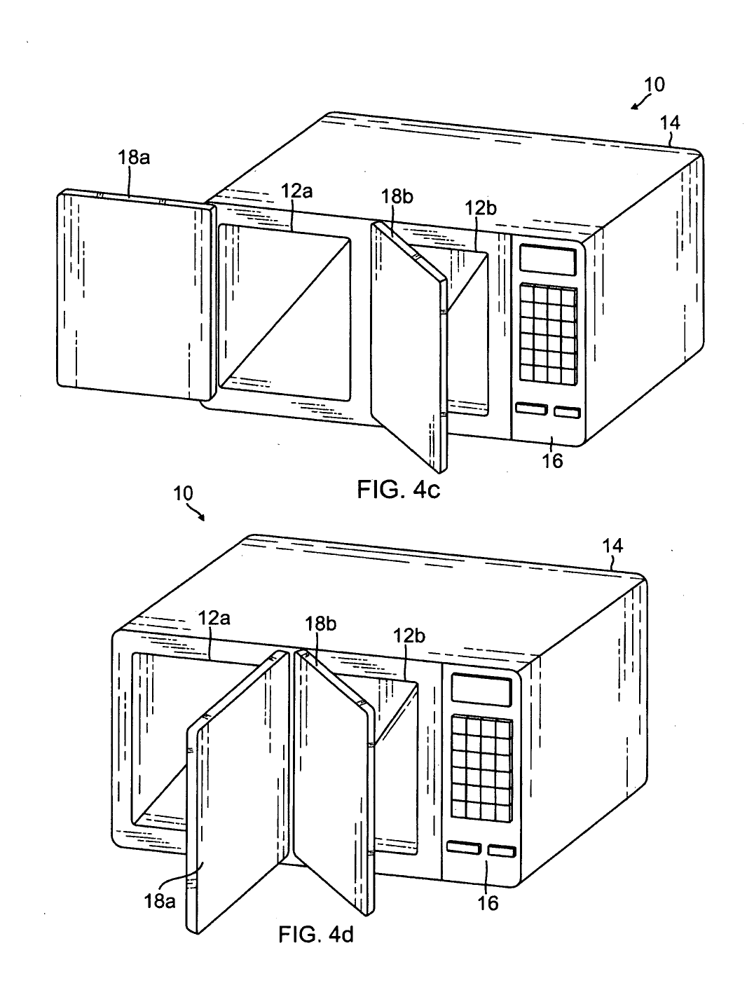

FIGS. 4a-4d are schematic drawings illustrating various door configurations according to embodiments of the present invention.

Referring to FIGS. 4a-4d, the two doors 18a and 18b are hinged to the cabinet 14 and rotatable around an axis parallel to the height direction of the cabinet. In FIGS. 4a and 4d, the door 18a and the door 18b rotate in different directions when opening and closing the cooking chambers 12a and 12b, respectively. In FIGS. 4b and 4c, the door 18a and the door 18b rotate in the same direction when opening and closing the cooking chambers 12a and 12b, respectively.

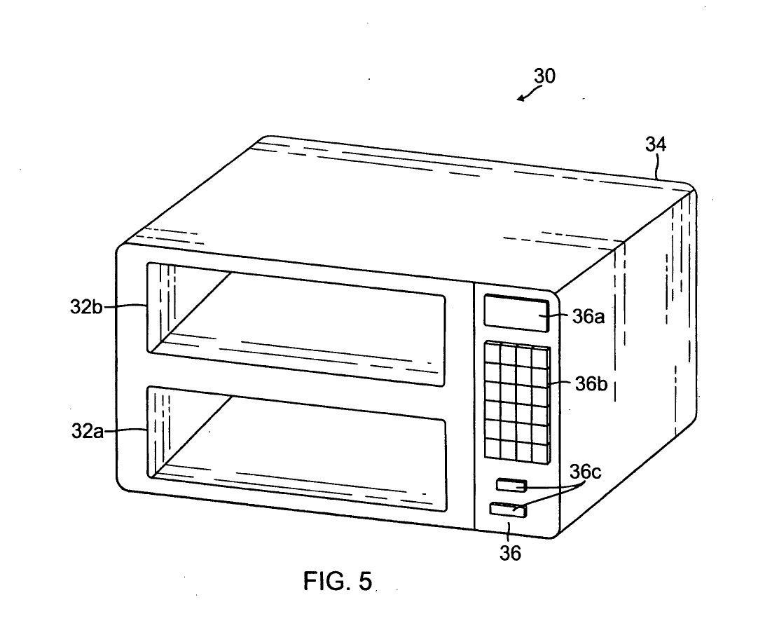

FIG. 5 is a schematic drawing illustrating a perspective view of a microwave oven according to an embodiment of the present invention.

Features of the embodiment of FIG. 5 similar to those of the embodiments of FIGS. 1-3 and 4a-4d are omitted for the ease of description. Referring to FIG. 5, a microwave oven 30 includes a cabinet 34 and two cooking chambers 32a and 32b within the cabinet 34. The two cooking chambers 32a and 32b are adjacent to each other in a vertical direction (i.e., the height direction of the microwave oven 30). Doors of the microwave oven 30, which are not shown in FIG. 5, will be described in the following paragraphs.

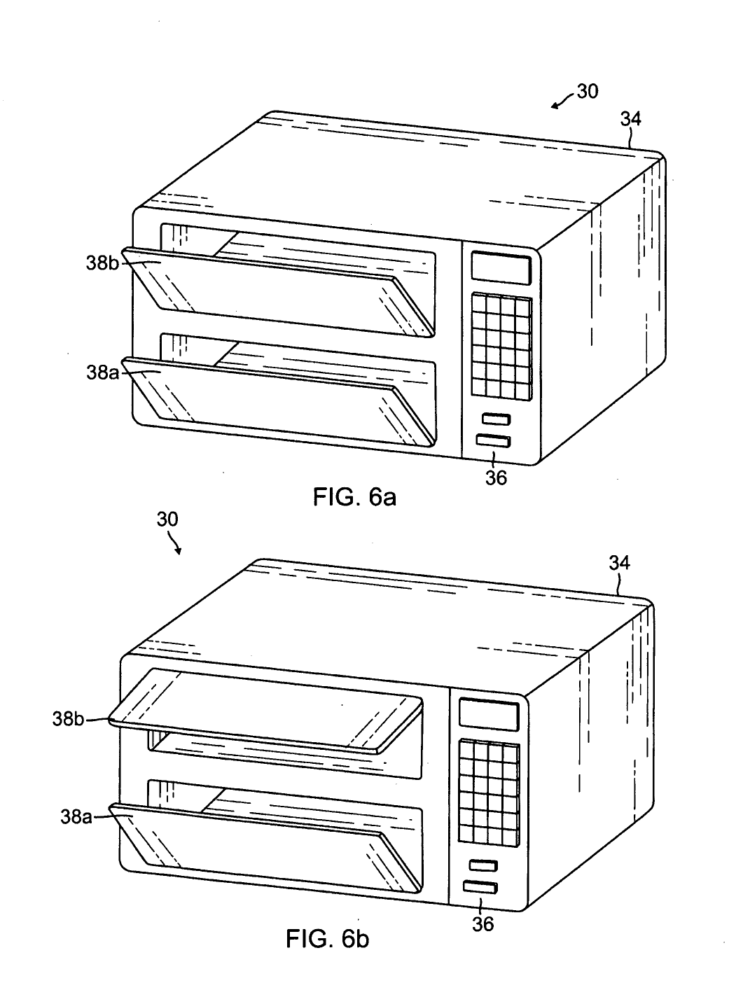

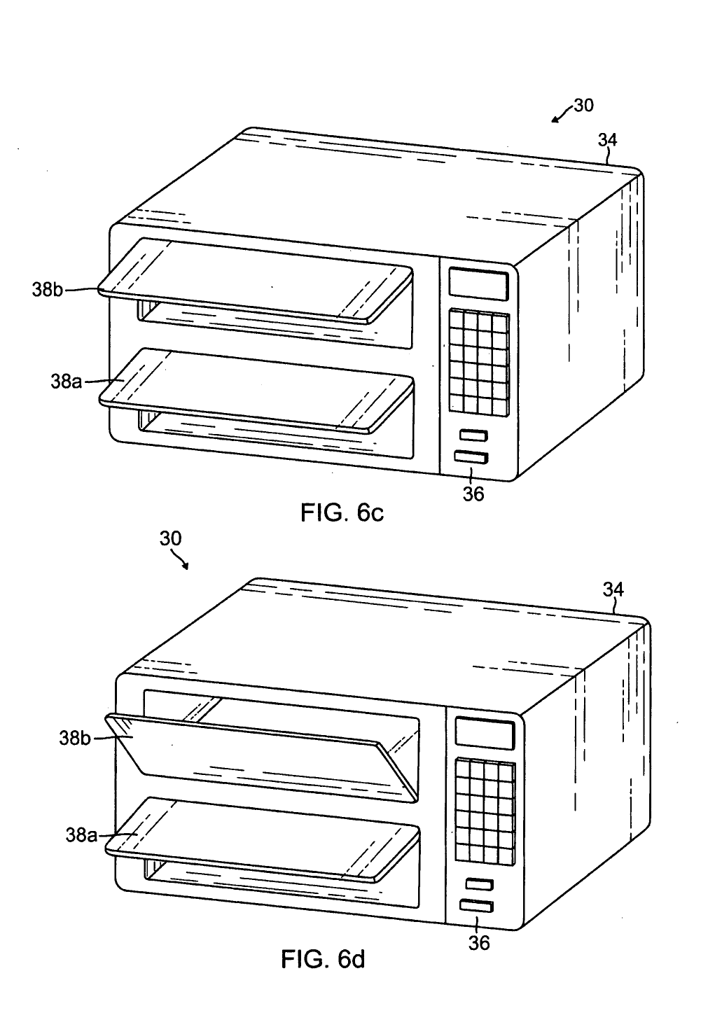

FIGS. 6a-6d are schematic drawings illustrating various door configurations of the microwave oven of FIG. 5 according to embodiments of the present invention. Some exemplary embodiments of the various door configurations includes doors that are suitably sized to accommodate food items such as pizzas, trays and other flat laying food items.

Referring to FIGS. 6a-6d, the two doors 38a and 38b are hinged to the cabinet 34 and rotatable around an axis parallel to the length direction of the cabinet 34. In FIGS. 6a and 6c, the door 38a and the door 38b rotate in the same direction when opening and closing the cooking chambers 32a and 32b, respectively. In FIGS. 6b and 6d, the door 38a and the door 38b rotate in different directions when opening and closing the cooking chambers 38a and 38b, respectively.

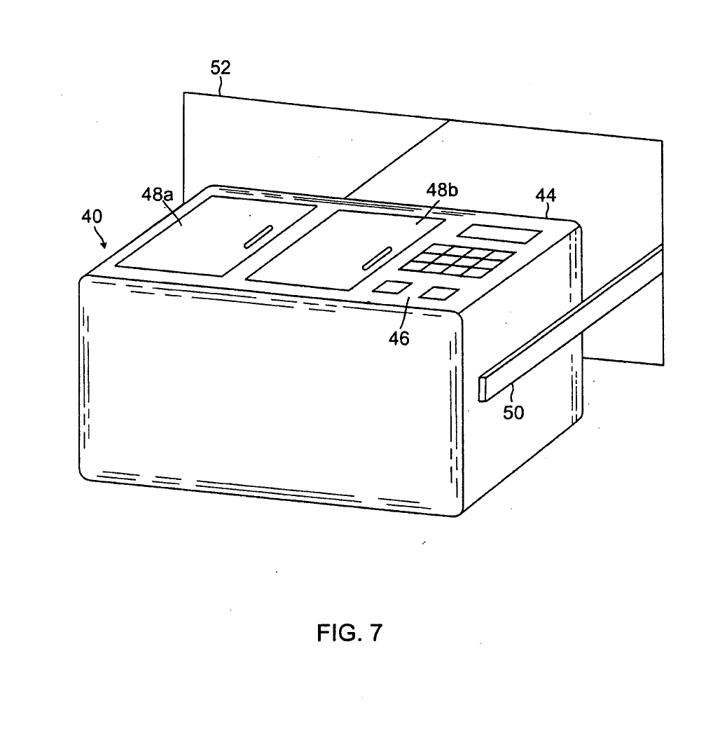

FIG. 7 is a schematic drawing illustrating a perspective view of an embodiment of the present invention.

For ease of description, elements of the microwave oven of FIG. 7 similar to those of the embodiments of FIGS. 1-3, 4a-4d, 5 and 6a-6d are omitted. Referring to FIG. 7, a microwave oven 40 configured to be integrated within a wall, drawer, cabinet, access areas, or other suitable openings is illustrated. The microwave oven 40 includes two separate cooking chambers (not shown) within a cabinet 44. The two cooking chambers are independently operable and each have a top facing doors 48a and 48b. The two doors 48a and 48b are movably connected to the top of the cabinet 44 for opening and closing the two cooking chambers respectively. In addition, the microwave oven 40 includes a control panel 46 for providing a user interface to operate the microwave oven 40. As such, the microwave oven 40 provides two top accessible independently operable cooking chambers.

In some embodiments, the microwave oven 40 includes sliders 50 or other suitable mechanisms for allowing the microwave oven 40 to be easily slid in and out of a space 52 among or within a wall, drawer, cabinet, access areas or other suitable openings. Therefore, when the microwave oven 40 is not being used, it can be concealed within the space 52 to provide a flush surface among other appliances to improve their aesthetic. In some embodiments, the microwave oven 40 includes a front panel (not shown) on its front surface to further improve its appearance. For example, the textual, color and/or pattern of the front panel may be similar to those of other kitchen appliances or the wall surrounding the microwave oven 40 to create a compatible look and feel. The present invention, however, is not limited thereto; instead, the microwave oven 40 may include more cooking chambers with corresponding doors in other embodiments of the present invention.

According to the above described embodiments of the present invention, a microwave oven with at least two cooking chambers in a single cabinet is provided. The at least two cooking chambers may be operated independently or concurrently. As such, multiple food items may be cooked and/or heated concurrently with different cooking parameters (e.g., power level and time duration). Further, one skilled in the art should appreciate that the described embodiments may be modified to provide more than two cooking chambers when multiple cooking chambers are desired.

While the present invention has been described in connection with certain exemplary embodiments, it is to be understood that the present invention is not limited to the disclosed embodiments, but, on the contrary, is intended to cover various modifications and equivalent arrangements included within the spirit and scope of the appended claims, and equivalents thereof.

What is claimed is:

1. A microwave oven comprising:
a cabinet;
at least two cooking chambers within the cabinet, each of the at least two cooking chambers having an opening at a corresponding side of the cabinet, the at least two cooking chambers being independently operable; and
at least two doors for opening and closing the respective openings of the at least two cooking chambers.

2. The microwave oven of claim 1, wherein the at least two cooking chambers are adjacent to each other vertically in a height direction of the cabinet.

3. The microwave oven of claim 1, wherein the at least two cooking chambers are adjacent to each other horizontally in a length direction of the cabinet.

4. The microwave oven of claim 1, wherein the at least two doors are rotatably hinged to the cabinet.

5. The microwave oven of claim 4, wherein the at least two doors are rotatable around an axis that is parallel to a height direction of the cabinet.

6. The microwave oven of claim 5, wherein the at least two doors are hinged to respective left edges of the at least two cooking chambers.

7. The microwave oven of claim 5, wherein the at least two doors are hinged to respective right edges of the at least two cooking chambers.

8. The microwave oven of claim 5,
wherein one of the at least two doors is hinged to a left edge of one of the at least two cooking chambers, and
another one of the at least two doors is hinged to a right edge of another one of the at least two cooking chambers.

9. The microwave oven of claim 4, wherein the at least two doors are rotatable around an axis that is parallel to a length direction of the cabinet.

10. The microwave oven of claim 9, wherein the at least two doors are hinged to respective lower edges of the at least two cooking chambers.

11. The microwave oven of claim 9, wherein the at least two doors are hinged to respective upper edges of the at least two cooking chambers.

12. The microwave oven of claim 9,
wherein one of the at least two doors is hinged to a top edge of one of the at least two cooking chambers, and
another one of the at least two doors is hinged to a bottom edge of another one of the at least two cooking chambers.

13. The microwave oven of claim 1, further comprising at least one heating unit for providing microwaves to the at least two cooking chambers.

14. The microwave oven of claim 13, wherein the at least one heating unit comprises at least one magnetron for providing microwaves to the at least two cooking chambers.

15. The microwave oven of claim 14, wherein the at least one heating unit comprises at least two magnetrons for providing microwaves to the least two cooking chambers respectively.

16. The microwave oven of claim 13, wherein the at least one heating unit comprises at least two heating units.

17. The microwave oven of claim 16, wherein each of the least two heating units comprises a magnetron for providing microwaves to a corresponding one of the at least two cooking chambers.

18. A microwave oven comprising:
a cabinet;
at least two cooking chambers within the cabinet, each of the at least two cooking chambers having an opening at a corresponding side of the cabinet, the at least two cooking chambers being independently operable;
at least two doors for opening and closing the respective openings of the at least two cooking chambers; and
a control panel for controlling the two cooking chambers.

19. The microwave oven of claim 18, wherein the control panel comprises a keypad for entering operation parameters of the at least two cooking chambers.

20. The microwave oven of claim 19, wherein the keypad comprises first keys allocated to control one of the at least two cooking chambers, and second keys allocated to control another one of the at least two cooking chambers.

21. The microwave oven of claim 19, wherein the keypad comprises a key for selecting one of the at least two cooking chambers to be controlled by subsequent inputs from the keypad.

22. The microwave oven of claim 19, wherein the control panel further comprises at least one display unit for concurrently displaying operation status of the at least two cooking chambers.

23. The microwave oven of claim 22, wherein the control panel further comprises at least two latches for independently controlling the opening and/or closing of the at least two doors.

24. The microwave oven of claim 23, further comprising at least one heating unit for providing microwaves to the at least two cooking chambers.

25. The microwave oven of claim 24, wherein the at least one heating unit comprises at least one magnetron for providing microwaves to the at least two cooking chambers.

26. The microwave oven of claim 25, wherein the at least one heating unit comprises at least two magnetrons for providing microwaves to the least two cooking chambers respectively.

27. The microwave oven of claim 24, wherein the at least one heating unit comprises at least two heating units.

28. The microwave oven of claim 27, wherein each of the least two heating units comprises a magnetron for providing microwaves to a corresponding one of the at least two cooking chambers.
